(19) United States
(12) Patent Application Publication
(10) Pub. No.: US 2010/0172719 A1
(43) Pub. Date: Jul. 8, 2010

(54) ASYMMETRICAL ENGINEERING FLOORING NAIL

(75) Inventors: Jacques Maltais, Beauport (CA); Marc Dion, Saint-Augustin-de-Desmaures (CA); David Lavoie, Quebec (CA)

Correspondence Address: FRASER CLEMENS MARTIN & MILLER LLC, 28366 KENSINGTON LANE, PERRYSBURG, OH, 43551, US

(73) Assignee: LABORATOIRE PRIMATECH INC., Quebec (CA)

(21) Appl. No.: 12/648,919

(22) Filed: Dec. 29, 2009

Related U.S. Application Data
(60) Provisional application No. 61/204,446, filed on Jan. 7, 2009.

(51) Int. Cl. F16B 15/00

(52) U.S. Cl. 411/468

(57) ABSTRACT

An asymmetrical engineering flooring nail for driving through an exposed surface of this flooring and fully thereinto. The nail defines an elongated shank having a transverse head at one end and a tapered tip at the opposite end; an intermediate portion of the shank includes a plurality of pairs of opposite teeth: Each transversely registering pair of opposite teeth are lengthwisely offset relative to one another by a small acute angle relative thereto; the number of first teeth on one side of shank is greater than the number of second teeth on the opposite side thereof, so that a smooth toothless upper side portion of said shank portion corresponds to the shank side of said second teeth is longer than that of the first teeth. Each of the opposite teeth forms an edge tooth, extending transversely outwardly beyond the longitudinal plane of the corresponding edge of the shank, and a trough, extending transversely inwardly through the longitudinal plane of the corresponding edge of shank, wherein the pitch and depth of each tooth will vary from one another of the teeth, in such a way as to optimize the features of the nail according to the hardwood flooring material.

### CROSS-REFERENCE TO RELATED APPLICATION

This application claims the benefit of U.S. Provisional Patent Application Ser. No. 61/204,446 filed on Jan. 7, 2009, hereby incorporated herein by reference in its entirety.

### FIELD OF THE INVENTION

This invention relates to nails used for securing together superimposed flooring workpieces.

### BACKGROUND OF THE INVENTION

Prior art fasteners for magazine feeding of a plunger-type nailing machines have been described for example in U.S. Pat. No. 6,139,238 issued Oct. 31, 2000 to Powernail Co. Such fasteners, also called cleats or nails, can be used to install tongue and groove wood flooring and other fibrous workpieces. Such fasteners are characterized by having a shank of preselected width, with a fastener head extending perpendicularly from one end of the shank thereof, and a tapered tip projecting from the opposite end thereof for penetrating the workpiece. A plurality of teeth project from at least one side—but usually from both opposite sides in corresponding pairs—of the shank and extend from an intermediate position along the shank to nearly the tip thereof.

T-shape and L-shape prior art nails have been known for more than sixty (60) years. These nails are often stamped from rolled steel sheets and formed into strips for continuous/magazine feeding. Each of these prior art nails has a shank having teeth symmetrically disposed on opposite sides of the shank and all teeth identical to one another; the number of teeth on one side of the shank being identical to the number of teeth on the opposite side thereof. Perfect symmetrical teeth layout on T-shape nail shank is usually the case. That is to say, each pair of registering nail shank teeth extend within a plane exactly orthogonal to the lengthwise axis of the nail shank. It is noted that nails are not screws, since in screws, the lengthwisely spiralling groove formed along the screw shank forms by definition an asymmetric thread layout on opposite sides of the screw shank. Indeed, the dynamics of downwardly spiralling screw penetrating by screws in wood material is fundamentally different from that of the impact driven straight axial (non spiralling) penetration of a nail. Moreover, the toothed shank section of these prior art nails is usually angularly inclined to form a tapered segment. The prior art nails head is of standard shape. The exposed free end tip of these prior art nail shank is usually rounded (i.e. convex).

Sixty years ago, when the original magazine feed fastener was invented, floorings were manufactured from hardwood such as oak, maple, and the like, and were laid against an underlying sub-flooring made of plywood boards. However, the popularity of engineered floorings and the like state of the art wood floorings has become obvious in the last ten to fifteen years. These engineered floorings have a very thin top surface layer made from hardwood and have an underlying structure similar to that of plywood boards. With conventional flooring fasteners, there is no tooth on the upper shank section, and thus the fastener provides very little retention force in the board at this section of the shank. On the other hand, sixty years ago, the hardwood boards did provide a good retention even at the upper toothless shank section of the nails.

Another problem encountered by the hardwood flooring industry is the dimples generated at the exposed surfaces of the flooring. Any fastener forcibly inserted into wood will reactively induce a shift in the wood fibers. This shift may extend up to the exposed surface thereof and become apparent under particular circumstances, for example when using a very bright varnish.

A typical prior art nail will have a slightly conical main shank for example a conicity angle of about 3° for T-shape nails and a conicity angle ranging between at least 1° and up to 2° for the L-shape nails. That is to say, these conicity angles represent the angular value made between two planes extending through the combined crests of the teeth on both of the opposite sides of the nail shank. Such conicity angle affects performance related to ease of nail shank penetration into wood material and tear resistance force to nail shank withdrawal from the wood material into which it is embedded. Because of its lower angular conicity, the L-shape nail typically requires less driving force to penetrate into wood relative to the T-shape nail.

It is noted that initially, it is mainly the nail teeth that contribute to the good wood retention force, whereas the conicity angle of the nail shank is substantially irrelevant for this performance. On the other hand, upon nail movement being generated, a substantial difference in performance is achieved, thanks to the nail teeth, when the nail is to be forcibly removed from the wood material into which it has been driven and has become embedded into. With a conicity angle equal to or greater than 1°, any partial nail withdrawal from the wood material into which it has been previously driven will substantially reduce this retention force and will break the interlock link between the nail shank and this wood material, so that the nail will become substantially loose inside the wood material passageway into which it is lodged. Hence, nail withdrawal force will have become much smaller thereafter.

Moreover, it is noted that flooring nails may be installed by manual or pneumatic driven tools. When manual tools are used, the resistance to wood penetration of the fastener is large, meaning that the operator must expend a large amount of energy. Fasteners with angularly tapered toothed shanks require a greater expenditure of energy for driving same than a smooth shank fastener.

### SUMMARY OF THE INVENTION

The invention relates to an asymmetrical engineering flooring nail for driving through an exposed surface of this flooring and fully into this flooring said nail defining an elongated shank having a transverse head at one end and a tapered tip portion at the opposite end and an intermediate portion of said shank between said head and said tapered tip portion includes a plurality of pairs of opposite teeth; each transversely registering pair of opposite teeth are lengthwisely offset relative to one another by a small angular offset relative thereto; each of the opposite teeth forms a crest, extending transversely outwardly beyond the longitudinal plane of the corresponding edge of said shank, and a trough, extending transversely inwardly through the longitudinal plane of the corresponding edge of shank, wherein the pitch and depth of each tooth will vary from one another of said teeth, in such a way as to optimize the features of the nail according to the selected flooring.

Preferably, there is further included, at a location adjacent from said head, an additional single tooth further projecting transversely outwardly from said shank in a direction opposite said head, the latter tooth being slightly offset from a transverse plane intersecting said head perpendicularly to the lengthwise axis of said shank relative to said tapered tip portion, wherein said additional single tooth enables to minimize fiber shift dimple formation at an exposed surface of the flooring upon said nail being driven into the engineering flooring.

A shallow notch could be made against the underface of said head adjacent said shank.

Also, a second additional single tooth could project transversely outwardly from shank in the same direction as said head; the location of the latter tooth being intermediate said notch and the topmost tooth of said nail shank intermediate portion.

Preferably, said shank tapered tip portion defines an exposed free end surface of a shape selected from the group comprising a flat tip surface and a concave tip surface.

Preferably, said small angular offset represents from 10 to 50% of the pitch value between two consecutive said teeth, most preferably being about 10% of pitch value.

Preferably, the depth of each of said tooth is smaller than the pitch value between the crests of two consecutive said teeth.

Said shank tapered tip portion could define a non-conical outer free end portion and a conical inner end portion, the latter portion being larger than the former portion.

Preferably, said shank intermediate portion has substantially zero conicity.

### BRIEF DESCRIPTION OF THE DRAWINGS

FIG. 1 is a perspective view of a conventional driven type fastener used in magazine fed nailing machine;

FIG. 2 is a view similar to that of FIG. 1, but showing a first embodiment of the present invention with the nail shank having a flat end tip;

FIG. 3 is a view similar to that of FIG. 1, but from another perspective;

FIG. 4 is a view similar to FIG. 3 but showing a second preferred embodiment of asymmetrical nail according to the invention, with the nail shank having a concave end tip;

FIGS. 5, 5a and 5b are a plan view, and two opposite edge views of the embodiment of nail of FIG. 2; and

FIGS. 6 and 7 are isometric views of a three-layer laminate flooring, showing the prior art fastener of FIGS. 1 and 3 on the right hand side of FIG. 6 and on the left hand side of FIG. 7, and the embodiment of nail of FIG. 2 on the left hand side of FIG. 6 and on the right hand side of FIG. 7, and suggesting how an upper tongue and groove edgewise connector flooring can be anchored to an underlying continuous flooring and to a topmost exposed hardwood flooring layer.

### DETAILED DESCRIPTION OF THE PREFERRED EMBODIMENTS OF THE INVENTION

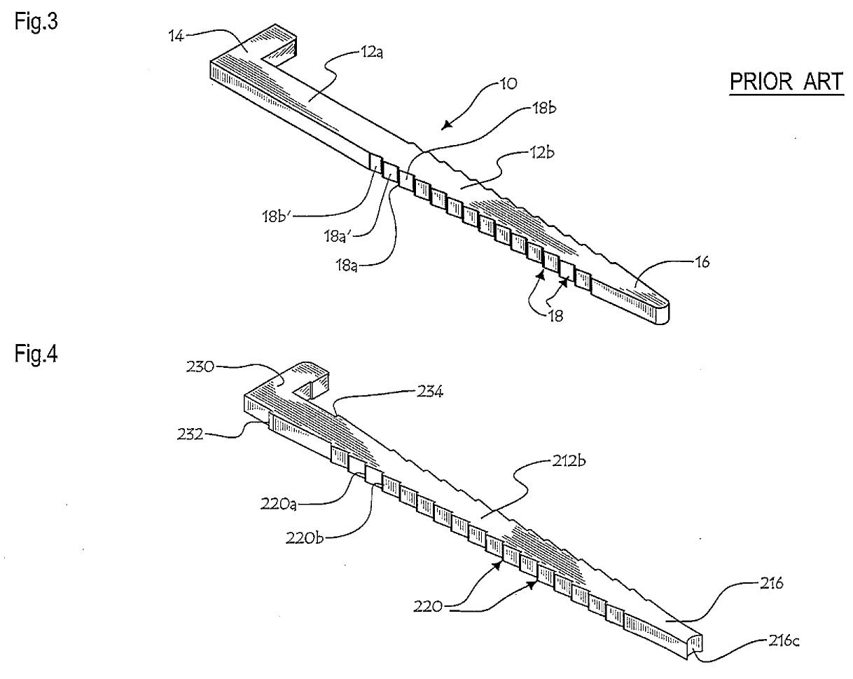

The prior art fastener 10 shown in FIGS. 1 and 3 defines an elongated shank 12, generally quadrangular in cross-section, having a transverse head 14 at one end and a tapered tip 16 at the opposite end. An upper portion 12a of shank 12, for example the upper third portion of shank 12, is tooth-less and smooth, while an intermediate portion 12 b of shank 12, between tip 16 and upper portion 12a, includes a series of pairs of opposite teeth 18, 20. Each tooth 18, 20, forms a crest 18a, 20a, extending transversely outwardly beyond the longitudinal plane of the corresponding edge of shank upper portion 12a, and a trough 18b, 20b, extending transversely inwardly through the longitudinal plane of the corresponding edge of shank upper portion 12a. The depth of each tooth 18, 20, is much smaller than the pitch (distance between the crests 18a, 18a′, of two consecutive teeth 18′, 18″, from the same side) thereof, so that only small wood retention can be achieved. Each tooth 18 has an opposite tooth 20 coplanar to one another along a plane perpendicular to the lengthwise axis of fastener shank 12.

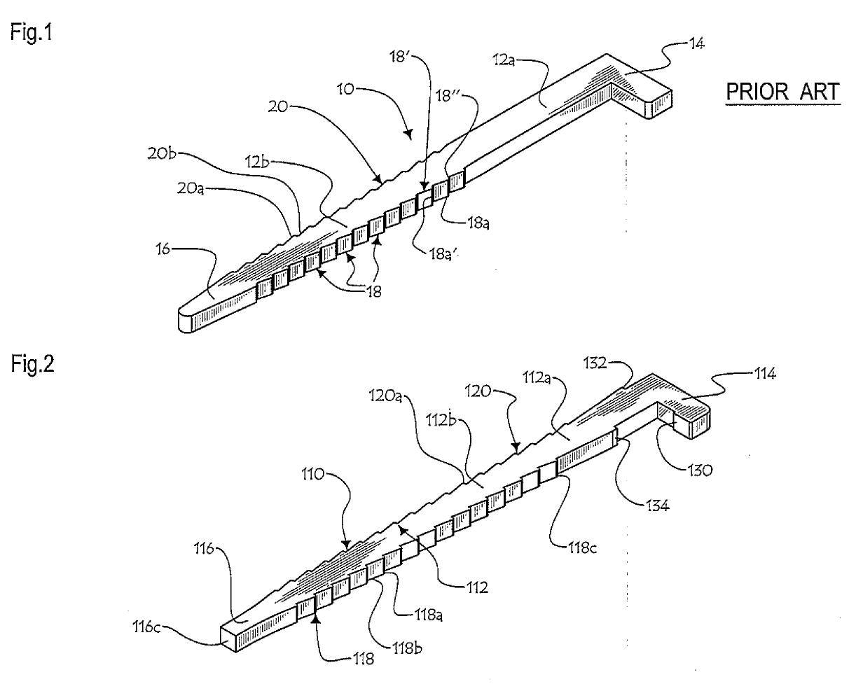

According to the invention, and as illustrated in FIGS. 2,4, and 5, 5a, 5b, of the drawings, the present invention nail 110 defines an elongated shank 112, generally quadrangular (preferably rectangular) in cross-section, having a transverse head 114 at one end and a tapered tip 116 at the opposite end. An intermediate portion 112b of shank 112 includes a plurality of pairs of opposite teeth 118, 120. Each transversely registering pair of opposite teeth 118 and 120 are lengthwisely offset relative to one another, i.e. that the plane intersecting these two opposite teeth is offset relative to a plane perpendicular to the lengthwise axis of shank 112, by a small angular offset. Preferably, this angular offset represents from 10 to 50% of the total (100%) pitch value between two consecutive teeth, most preferably about 10% of said pitch value. More particularly, this angular offset may form an angle of for example 4° made between a first virtual line joining tooth teeth 118a on one side of shank toothed portion 112b, and a second virtual line joining tooth teeth 120a on the opposite side of shank toothed section 112b, at a virtual convergence point of said first and second virtual lines beyond the tip 116.

Such asymmetrical tooth layout enables to unexpectedly increase the maximum size threshold of the shank (beyond which wood damage would follow), as well as enables optimization of the nailing performance, such as ease of wood driving and retention force.

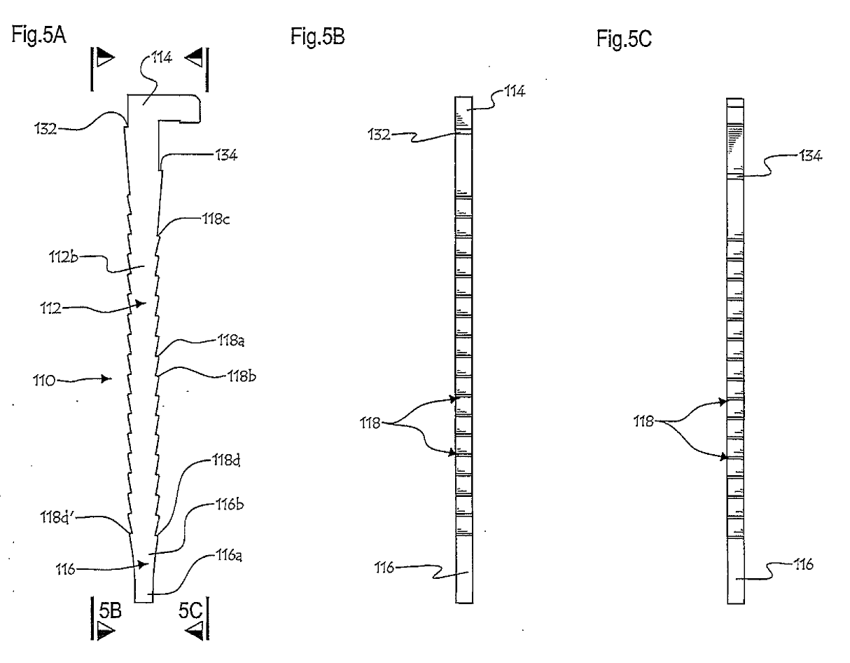

According to one feature of the invention, and as illustrated in FIG. 5a, the nail has substantially zero nail shank conicity about its main teeth carrying intermediate section 112. This feature minimizes driving force required for nail shank penetration into wood. By substantially zero conicity for main shank portion 112, we mean substantially less than 1° conicity down to equal to or greater than 0° conicity, It is understood that it will be harder to drive a prior art toothed nail having a non zero conicity angle at its tooth shank portion since, as the nail shank progressively penetrates into wood, the nail shank passage into the wood material needs to progressively widen accordingly.

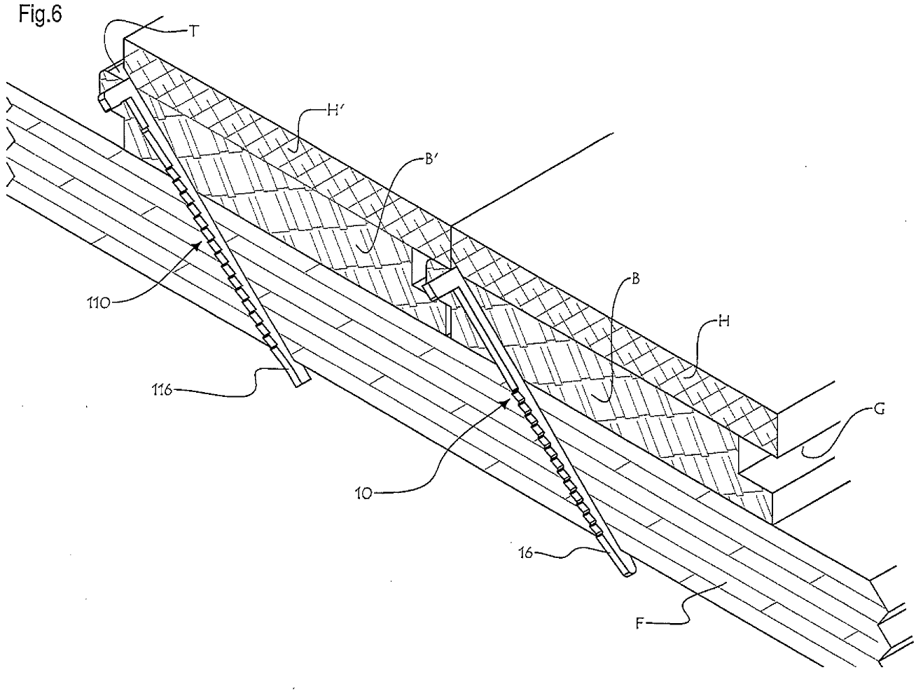

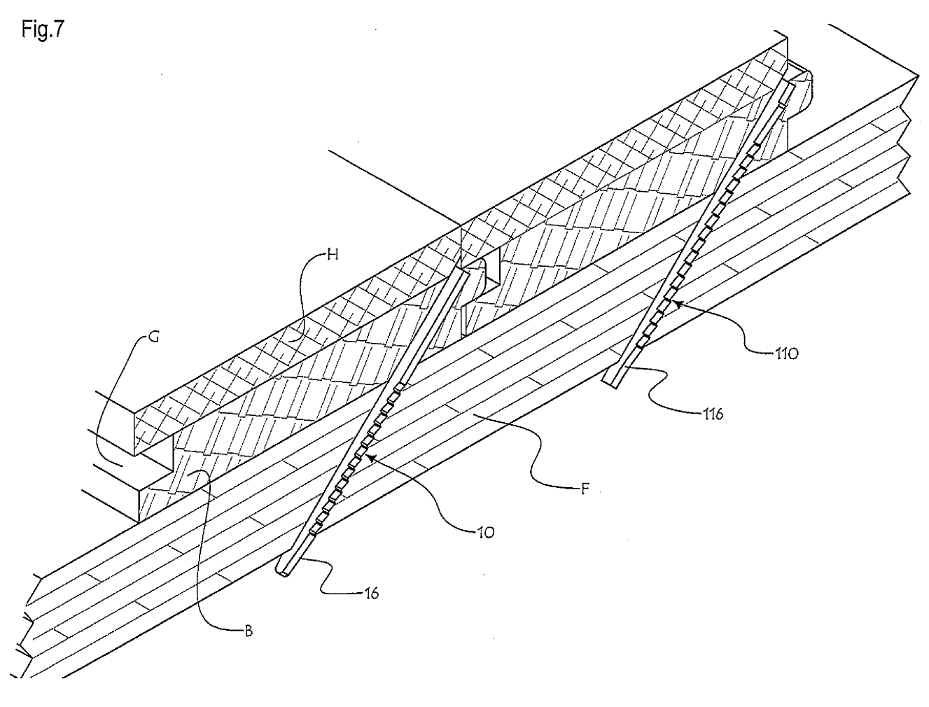

On the contrary, with the nail according to the present embodiment of the invention, some initial driving effort is required, as the nail tip portion 116 engages the wood at the corner formed by the junction between the tongue T and an upright building wall (not shown), at the co-called “nail pocket”. Indeed flooring panel manufacturers usually and conventionally provide such a nail pocket or trough at this junction, to facilitate nail engagement. Hence, the nail does not engage the exposed wood surface H, H′. FIG. 6 clearly shows the nail position inside the wooden plank; the nail engages into the wood exactly where the nail head ends. Beyond the nail tip portion 116, no wood passageway widening is required other than to accommodate the passage of the teeth: only friction resistance needs to be overcome.

It is noted that with a zero conicity for nail main tooth carrying shank portion 112, the wood fibers will unexpectedly continue to apply an interlock engagement load with the nail shank 112, even if there has been a partial forcible withdrawal of the nail from the wood material into which the nail has been previously driven.

Moreover, it is noted that with respect to the zero conicity of the outer end tip portion 116a (FIG. 5a) of nail 110, improved and unexpected performance is achieved by enabling minimizing wood tongue cracking.

Moreover, the number of teeth 120 on one side of shank 112 is preferably greater than the number of teeth 118 on the opposite side thereof, so that the smooth toothless side of upper shank portion 112a corresponding to the side of teeth 118 is longer than the opposite side of teeth 120.

Each tooth 118, 120, preferably forms a rounded i.e. slightly curved crest 118a, 120a, extending transversely outwardly beyond the longitudinal plane of the corresponding edge of shank upper portion 112a, and a trough 118b, 120b, extending transversely inwardly through the longitudinal plane of the corresponding edge of shank upper portion 112a. The depth of each tooth 118, 120, is much smaller than the pitch thereof, but the pitch and depth of each tooth 118, 120 will vary from one another, so as to optimize the features of the fastener, for example, its retention, accordingly with the specific layers of wood that need to be engaged.

A shallow notch 130 is made against the underface of head 114 adjacent shank 112. This notch 130 contributes in minimizing damage to exposed hardwood panel surface H.

At a location adjacent from head 114, an additional single tooth 132 further projects transversely outwardly from shank 112 in a direction opposite head 114. Tooth 132 is slightly offset from a transverse plane intersecting head 114 perpendicularly to the lengthwise axis of shank 112 relative to tapered tip 116. Unexpectedly, it was discovered that this nail head tooth 132 enables to minimize formation of damaging wood fiber shifting dimples on the exposes top surface of the floor panels into which is impact driven the nail; this is particularly the case during the last leg of impact driven nail penetration into the wood when the nail head engages and becomes substantially embedded into the floor panel top exposed surface H coplanar thereto.

A further single tooth 134 projects transversely outwardly from shank 112, in the same direction as head 114. The location of tooth 134 is intermediate notch 130 and the topmost tooth 118c. Tooth 134 provides enhanced wood enchoring due to its asymmetric layout.

The alternate embodiment of nail shown in FIG. 4 is identical to that one of FIG. 2, except to show a nail shank tip being concave instead of flat. All other corresponding reference numerals are upgraded to 200-series: for example, head 130 of FIG. 2 becomes heads 230 in FIG. 4.

As suggested by FIGS. 2 and 4-6 of the instant drawings, teeth 132, 134, located about the shank upper portion 112a, provides a better retention by the nail 110 not only for the underlying plywood flooring F, but also for the overlying tongue and groove connecting means T, G, of plywood wooden boards B, B′, and for exposed hardwood layer H, H′. This improved retention is much more important nowadays with the widespread use of soft wood or engineering flooring in the manufacture of wooden boards.

The exposed hardwood wear surface H, H′, typically represents only between 10 to 30% of the total combined depth of wood layers F, B and H. Hardwood wear surface layer H usually has a minimum thickness of about 2 millimeters. Wood layers F, B and H may also be further interconnected flatly against one another by a conventional wood glue.

It is noted that the prior art toothless nails still provided good retention in hardwood floorings; on the other hand, these toothless nails cannot provide any anchoring retention in state of the art engineering floorings, since latter have a thin exposed top hardwood layer with underlying plywood boards. With nails according to the present invention, the angular offset between transversely registering teeth 118, including the head tooth 134, provides unexpected retention force in the wood flooring, while maintaining strong retention at the underflooring level. This angular offset, ranging from 10 to 50% of the relative pitch (for example, corresponding to a transversely angular offset angle of about 4°), improves substantially the nail anchoring action in the direction of the plywood ply. Moreover, this transverse teeth offsetting enables, for a given size of the nail shank 112, to increase the minimal cross-section of the nail shank 112, i.e. from tooth trough to tooth trough (between two crests 118a, 118b) of a pair of transversely registering teeth 118. This allows rigidity enhancement of the nail 110 for a given nail geometry.

As already discussed herein above, dimples are generated at the exposed surfaces of the prior art flooring, since any prior art fastener inserted into wood will induce a shift in the wood fibers which may extend up to the exposed surface thereof and become apparent. The asymmetrical tooth layout on the present invention fastener shank—i.e. the fact that the number of teeth 118 on one side of the shank 112 is different than the number of teeth 120 on the opposite side of the shank, and the fact each pair of opposite registering teeth 118, 120 are offset from a plane perpendicular to the lengthwise axis of shank 112—minimizes this undesirable fiber shifting effect in the flooring material.

As for the drawback of large resistance to wood penetration of prior art manually driven toothed shank fasteners, the present invention reduces the required wood penetration loads while still providing a substantial retention force thanks to the present invention nail teeth.

The free end tip of nail shank tip portion 116 is preferably flat (at 116c) or concave (at 216c). This will enable nail tip 116 to accommodate wooden material generating wood fiber shifting, thus minimizing dimpling effect. Moreover, by reducing the surface of first contact with the board tongue, tongue splitting hazards are minimized.

Another advantage of the present invention is a decrease in the required impacting force required to drive the present invention nail into a given wood flooring. A further advantage thereof is a better wood panel retention in engineering floors.

I claim:

1. An asymmetrical engineering flooring nail for driving through an exposed surface of this flooring and fully into this flooring, said nail defining an elongated shank having a transverse head at one end, a tapered tip portion at the opposite end and an intermediate portion of said shank between said head and said tapered tip portion, said intermediate portion includes a plurality of pairs of opposite teeth; each transversely registering pair of opposite teeth are lengthwisely offset relative to one another by a small angular offset relative thereto; each of the opposite teeth forms a crest, extending transversely outwardly beyond the longitudinal plane of the corresponding edge of said shank, and a trough, extending transversely inwardly through the longitudinal plane of the corresponding edge of shank, wherein the pitch and depth of each tooth will vary from one another of said teeth, in such a way as to optimize the features of the nail according to the selected flooring.

2. A nail as in claim 1,
further including, at a location adjacent from said head, an additional single tooth further projecting transversely outwardly from said shank in a direction opposite said head, the latter tooth being slightly offset from a transverse plane intersecting said head perpendicularly to the lengthwise axis of said shank relative to said tapered tip portion, wherein said additional single tooth enables to minimize fiber shift dimple formation at an exposed surface of the flooring upon said nail being driven into the engineering flooring.

3. A fastener as in claim 2,
further including a shallow notch made against the underface of said head adjacent said shank.

4. A fastener as in claim 3,
further including a second additional single tooth, projecting transversely outwardly from shank in the same direction as said head; the location of the latter tooth being intermediate said notch and the topmost tooth of said nail shank intermediate portion.

5. A nail as in claim 2,
wherein said tapered tip portion defines an exposed free end surface of a shape selected from the group comprising a flat tip surface and a concave tip surface.

6. A nail as in claim 2,
wherein said small angular offset represents from 10 to 50% of the pitch value between two consecutive said teeth.

7. A nail as in claim 6,
wherein said small angular offset is of about 10% of said pitch value.

8. A nail as in claim 2,
wherein the depth of each of said tooth is smaller than the pitch value between the crests of two consecutive said teeth.

9. A nail as in claim 2,
wherein said shank tapered tip portion defines a non-conical outer free end portion and a conical inner end portion, the latter portion being larger than the former portion.

10. A nail as in claim 2,
wherein said shank intermediate portion has substantially zero conicity.

11. A nail as in claim 9,
wherein said shank intermediate portion has substantially zero conicity.

12. A nail as in claim 5,
wherein said shank tapered tip portion defines a non-conical outer free end portion and a conical inner end portion, the latter portion being larger than the former portion.
